(19) United States
(12) Patent Application Publication
(10) Pub. No.: US 2026/0336656 A1
(43) Pub. Date: Oct. 29, 2026

(54) AUTONOMOUS VEHICLE CONTROL DEVICE AND METHOD

(71) Applicants: Hyundai Motor Company, Seoul (KR); Kia Corporation, Seoul (KR)

(72) Inventors: Yang Woo LEE, Hwaseong-si (KR); Se Hyun YUN, Hwaseong-si (KR)

(73) Assignees: Hyundai Motor Company, Seoul (KR); Kia Corporation, Seoul (KR)

(21) Appl. No.: 19/387,235

(22) Filed: Nov. 12, 2025

(30) Foreign Application Priority Data
Apr. 29, 2025 (KR) 10-2025-0055999

(51) Int. Cl. B60W 60/00; B60W 50/00

(52) U.S. Cl. CPC B60W 60/001; B60W 50/00; B60W 2050/0052; B60W 2556/40; B60W 2556/45

(57) ABSTRACT

An autonomous vehicle control device includes a transceiver, one or more sensors, one or more processors operatively connected to the transceiver and the one or more sensors, and the sensor is configured to detect an external object around a vehicle to generate object recognition information and collects driving data of the vehicle to generate vehicle driving information, the transceiver receives map information including travel trajectory data of adjacent vehicles from a map server, and the processor is configured to determine a lane centerline of a driving road based on the vehicle driving information and the object recognition information divide the driving road into a plurality of segments based on the lane centerline of the driving road, determine a distribution of vehicle travel trajectories for each of the divided segments, determine a drivable path connecting the segments based on the distribution of the vehicle travel trajectories, and control the autonomous vehicle according to the drivable path.

### CROSS-REFERENCE TO RELATED APPLICATION

The present application claims priority to and the benefit of Korean Patent Application No. 10-2025-0055999, filed on Apr. 29, 2025, the present disclosure of which is incorporated herein by reference in its entirety.

### BACKGROUND

### Field of the Present Disclosure

The present disclosure relates to an autonomous vehicle control device and method.

### Discussion of Related Art

Autonomous driving technology is a technology that allows a vehicle to travel on roads by itself without driver intervention, and has been rapidly growing with the recent advancement of the automobile industry and artificial intelligence technology. Autonomous vehicles utilize sensors, processors, and communication modules to perceive their surroundings, plan paths, and control the vehicles. In these autonomous driving systems, path planning is a key element and serves to generate a driving path that allows the vehicle to reach its destination safely and efficiently.

In recent years, in some autonomous driving systems, methods of generating driving paths by utilizing vehicle driving data have been suggested. The vehicle driving data includes travel trajectory data of a host vehicle and adjacent vehicles, and through the travel trajectory data, road lane structures and driving patterns may be estimated. However, the method of generating paths based on vehicle driving data has the drawback of requiring a large amount of driving data. When the amount of driving data is insufficient, the accuracy of path generation is low and the path is likely to be distorted, especially in a complex environment such as a curved section of a road or an intersection. Furthermore, there is a limitation in reflecting real-time road situations, and there is a problem that path generation may be distorted due to noise or abnormal data (e.g., lane change, abnormal path) in travel trajectory data.

### BRIEF SUMMARY

Various aspects of the present disclosure is directed to providing an autonomous vehicle control device and method that generates a drivable path in which a real-time road situation is reflected by utilizing a small amount of vehicle driving data.

According to various aspects of the present disclosure, there is provided an autonomous vehicle control device including a transmitting/receiving unit, one or more sensors, one or more processors operatively connected to the transceiver and the one or more sensors, and a memory storing one or more programs executed by the one or more processors, in which the sensor is configured to detect an external object around an autonomous vehicle to generate object recognition information and collects driving data of the vehicle to generate vehicle driving information, the transceiver receives map information including travel trajectory data of adjacent vehicles from a map server, and the processor is configured to determine a lane centerline of a driving road based on the vehicle driving information and the object recognition information divide the driving road into a plurality of segments based on the lane centerline of the driving road, determine a distribution of vehicle travel trajectories for each of the divided segments, determine a drivable path connecting the segments based on the distribution of the vehicle travel trajectories, and control the autonomous vehicle according to the drivable path.

The processor is configured to determine the lane centerline based on travel trajectory data included in the vehicle driving information.

The processor may be configured to divide the segments based on a center point of the lane centerline and determine a vehicle travel trajectory that intersects the lane centerline at the same longitudinal position as a cross point.

The processor may filter the cross point based on a difference value between a heading direction of the lane centerline and a heading direction of the vehicle travel trajectory.

The processor may transform the filtered cross points into a center point coordinate system of the lane centerline.

The processor is configured to determine drivable path points for each segment based on a sliding window method.

The processor may merge cross points of adjacent segments and determine the drivable path points based on a distribution ratio of the merged cross points.

The processor may be configured to merge the cross points of the adjacent segments into a central segment coordinate system and estimate a probability density function (PDF) local maximum through kernel density estimation (KDE) and select the drivable path points.

The processor may filter drivable path points through which a preset number of travel trajectories or fewer have passed.

The processor is configured to generate the drivable path by connecting the drivable path point for each segment.

According to various aspects of the present disclosure, there is provided an autonomous vehicle control method that is executed by a computing device including a transceiver, one or more sensors, one or more processors operatively connected to the one or more sensors, and a memory storing one or more programs executed by the one or more processors, including detecting, by the sensor, an external object around an autonomous vehicle to generate object recognition information and collecting driving data of the vehicle to generate vehicle driving information, receiving, by the transceiver, map information including travel trajectory data of adjacent vehicles from a map server, determining, by the processor, a lane centerline of a driving road based on the vehicle driving information and the object recognition information, dividing, by the processor, the driving road into a plurality of segments based on the lane centerline of the driving road, determining, by the processor, a distribution of vehicle travel trajectories for each of the divided segments, determining, by the processor, a drivable path connecting the segments based on the distribution of the vehicle travel trajectories, and controlling, by the processor, the autonomous vehicle according to the drivable path.

In the determining of the lane centerline of the driving road, the lane centerline may be determined based on travel trajectory data included in the vehicle driving information.

In the dividing of the road into the plurality of segments, the segments may be divided based on a center point of the lane centerline and a vehicle travel trajectory that intersects the lane centerline at the same longitudinal position may be determined as a cross point.

The autonomous vehicle control method may further include filtering, by the processor, the cross point based on a difference value between a heading direction of the lane centerline and a heading direction of the vehicle travel trajectory.

The autonomous vehicle control method may further include transforming, by the processor, the filtered cross point into a center point coordinate system of the lane centerline.

In the determining of the drivable path, drivable path points for each segment may be determined based on a sliding window method.

In the determining of the drivable path, cross points of adjacent segments may be merged and the drivable path point may be determined based on a distribution ratio of the merged cross points.

In the determining of the drivable path, the cross points of the adjacent segments may be merged into a central segment coordinate system, a PDF local maximum may be estimated through KDE, and the drivable path points may be selected.

The determining of the drivable path may further include filtering drivable path points through which a preset number of travel trajectories or fewer have passed.

The determining of the drivable path may include generating the drivable path by connecting the drivable path point for each segment.

### BRIEF DESCRIPTION OF THE DRAWINGS

The above and other objects, features and advantages of the present disclosure will become more apparent to those of ordinary skill in the art by describing various aspects thereof in detail with reference to the accompanying drawings, in which:

FIG. 1 is a view showing a vehicle transmitting and receiving data by communicating with other devices;

FIG. 2 is a diagram showing modules forming a vehicle according to an exemplary embodiment of the present disclosure;

FIG. 3 is a diagram for describing the operation of an autonomous vehicle control device according to an exemplary embodiment of the present disclosure;

FIG. 4, FIG. 5, FIG. 6, FIG. 7, FIG. 8, FIG. 9, FIG. 10, FIG. 11, FIG. 12, FIG. 13, and FIG. 14 are views for describing detailed operations of a processor according to an exemplary embodiment of the present disclosure; and

FIG. 15 is a flowchart of a method for controlling an autonomous vehicle according to an exemplary embodiment of the present disclosure.

### DETAILED DESCRIPTION OF EXEMPLARY EMBODIMENTS

Hereinafter, various exemplary embodiments of the present disclosure will be described in detail with reference to the accompanying drawings.

However, the technical idea of the present disclosure is not limited to various exemplary embodiments to be described but may be implemented in various different forms, and within the scope of the technical idea of the present disclosure, one or more among components in the exemplary embodiments of the present disclosure may be used by being selectively combined and substituted.

Furthermore, unless defined and described, terms used in the exemplary embodiments of the present disclosure (including technical and scientific terms) may be interpreted as meanings which are generally understood by those skilled in the art to which an exemplary embodiment of the present disclosure pertains, and commonly used terms such as terms defined in dictionaries may be interpreted in consideration of the contextual meaning of the related art.

The terms used in the exemplary embodiments of the present disclosure are for describing the exemplary embodiments only and are not intended to limit the present disclosure.

In the present specification, the singular forms may include the plural forms unless the context clearly dictates otherwise, and when described as “at least one (or one or more) among A, B, and (or) C,” it may include one or more of all possible combinations of A, B, and C.

Furthermore, when describing components of embodiments of the present disclosure, terms such as “first,” “second,” “A,” “B,” “(a),” “(b),” etc., may be used.

These terms are only for distinguishing the components from other components, and the essence, sequence, or order of the components is not limited by these terms.

Furthermore, when a component is described as being “linked,” “coupled,” or “connected” to another component, the component is not only directly linked, coupled, or connected to another component, but also “linked,” “coupled,” or “connected” to another component with yet another component disposed between the component and the other component.

Furthermore, when a component is described as being formed or disposed “on (above) or under (below)” another component, the term “on (above) or under (below)” includes not only when two components are in direct contact with each other, but also when one or more other components are formed or disposed between the two components. Furthermore, when a component is described as being “on (above) or below (under),” the description may include the meanings of an upward direction and a downward direction based on one component.

Hereinafter, various exemplary embodiments will be described in detail with reference to the accompanying drawings, but the same or corresponding components are denoted by the same reference numerals regardless of the drawing numbers, and redundant descriptions thereof will be omitted.

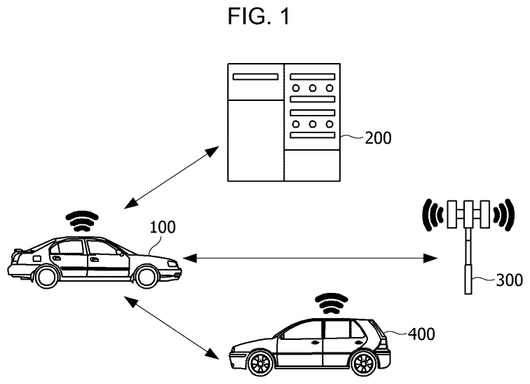

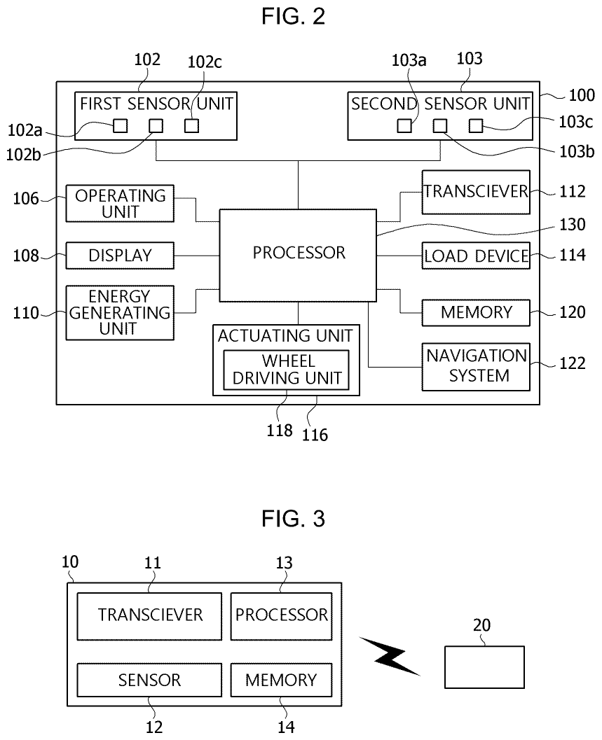

Hereinafter, a vehicle will be described with reference to FIG. 1 and FIG. 2. FIG. 1 is a view exemplarily illustrating a vehicle transmitting and receiving data by communicating with other devices.

Referring to FIG. 1, a vehicle 100 may be driven based on electrical energy or fossil energy. In the case of electrical energy, the vehicle 100 may be, for example, a pure battery-based vehicle driven by a high-voltage battery, or may employ a gas-based fuel cell as an energy source. Furthermore, the fuel cell may use various types of gas configured for generating electrical energy, and the vehicle 100 may be filled with gas, for example, in a liquefied state. Here, one example of the gas may be hydrogen. However, the gas is not limited thereto, and various gases are applicable. In the case of a vehicle driven based on fossil energy, the vehicle 100 is driven based on fuel such as gasoline, diesel or liquefied gas, and may be disposed with an internal combustion engine that drives an actuating unit 116 by combustion of the fuel. The engine may be included in an energy generating unit 110 in terms of providing a driving rotation force of wheels to a wheel driving unit 118. As an exemplary embodiment of the present disclosure, the vehicle 100 may drive the actuating unit 116 by selectively utilizing energy from a fossil energy-based internal combustion engine and an electric battery, and may be a hybrid type vehicle.

The vehicle 100 may refer to a movable device. The vehicle 100 is a ground vehicle that travels on the ground and may be a typical passenger vehicle, a commercial vehicle, a purpose-built vehicle (PBV), or the like. The vehicle 100 may be a four-wheeled vehicle, such as a passenger vehicle, a sports utility vehicle (SUV), or a small truck, or may be a vehicle with more than four wheels, such as a bus, a large truck, a container transport vehicle, a heavy equipment vehicle, or the like. Here, the ground vehicle may be referred to as any vehicle including a vehicle that moves underground as well as a vehicle that moves over land. The vehicle 100 may be a robot in a broad sense, such as a means of movement, and the robot may move using wheels, tracks, or other movement modules. In an exemplary embodiment of the present disclosure, ground mobility devices such as ground vehicles are mainly described, but unless it contradicts the present disclosure, the exemplary embodiment of the present disclosure may also be applied to air mobility devices such as an advanced air mobility (AAM), aircraft, or the like, and water mobility devices such as ships, submarines, or the like.

The vehicle 100 may be controlled and driven by autonomous driving, and the autonomous driving may be implemented as semi-autonomous driving or fully autonomous driving. Fully autonomous driving may be provided as autonomous movement in which a processor 130 of the vehicle 100 takes full control without user intervention, even when a driving situation is uncertain. Semi-autonomous driving may be provided as autonomous movement that requires driver intervention in some specific driving situations. The semi-autonomous driving may be implemented so that the processor 130 transfers control to a user by deactivating autonomous driving when the aforementioned situation occurs, allowing the user to perform manual driving. According to the levels of autonomous driving defined by the Society of Automotive Engineers (SAE), the semi-autonomous driving may correspond to autonomous driving levels 1 to 4, and the fully autonomous driving may correspond to level 5.

Meanwhile, the vehicle 100 may communicate with other devices 200 and 300 or another vehicle 400. Other devices may include, for example, a server 200 that supports various controls, state management, and driving of the vehicle 100, an intelligent transportation system (ITS) device 300 for receiving information from an ITS, various types of user devices, or the like. The server 200 may be, for example, an external device operated by a vehicle manufacturer or provided to service autonomous driving, and may receive connected data of the vehicle 100 or transmit data necessary for autonomous driving. The server 200 may transmit various pieces of information and software modules used to control the vehicle 100 to the vehicle 100 in response to requests and data transmitted from the vehicle 100 and the user device to support autonomous driving and various services of the vehicle 100.

The ITS device 300 may be, for example, a roadside unit (RSU), and the ITS device 300 may assist the user in driving his or her own vehicle or support autonomous driving of the vehicle 100 by exchanging vehicle recognition data, driving control and state data, environmental data around the vehicle, map data, or the like, through vehicle-to-infrastructure (V2I) communication with the vehicle 100. The vehicle 100 may support manual driving or autonomous driving by exchanging the data listed above through vehicle-to-vehicle (V2V) communication with the other vehicle 400.

The vehicle 100 may communicate with other vehicles or other devices based on cellular communication, wireless access in vehicular environment (WAVE) communication, dedicated short range communication (DSRC), short-range communication, or other communication methods.

For example, the vehicle 100 may use a cellular communication network such as LTE or 5G, a WiFi communication network, a WAVE communication network, or the like, for communication with the server 200, the ITS device 300, and the other vehicle 400. For another example, DSRC or the like used in the vehicle 100 may be used for communication between vehicles. The communication method between the vehicle 100, the server 200, the ITS device 300, the other vehicle 400, and the user device is not limited to the above-described embodiment.

FIG. 2 is a diagram showing modules forming a vehicle according to an exemplary embodiment of the present disclosure.

In the exemplary embodiment of the present disclosure, the vehicle 100 may be an autonomous vehicle. The vehicle 100 may include a sensor unit 102, an operating unit 106, a display 108, a load device 114, and a transceiver 112.

The sensor unit 102 may be disposed with various types of detectors to detect various states and situations occurring in an external environment, an internal system, a user operation, and a boarding space of the vehicle 100.

The first sensor unit 102 may be disposed with an externally oriented camera 102a, a Light Detection and Ranging (LiDAR) sensor 102b, a radio detection and ranging (RADAR) sensor 102c, and the like, to recognize dynamic and static objects present outside the vehicle 100. The camera 102a may recognize an external object as an image while the vehicle 100 is in use, generate image data, and transmit the image data to the processor 130. The LiDAR sensor 102b may be configured to generate point cloud data as recognized data of the external object and transmit the point cloud data to the processor 130 to generate 3D spatial information that identifies at least a shape of the external object. To ascertain the presence of an external object and its relative distance, speed, direction, or the like, the radio detection and ranging (RADAR) sensor 102c may emit radio waves of a specific frequency around the vehicle 100 and generate radio detection and ranging (RADAR) data through radio waves reflected from the external object. In an exemplary embodiment of the present disclosure, the sensor unit is illustrated as including the LiDAR sensor 102b, but in other examples, the LiDAR sensor 102b may not be disposed.

The first sensor unit 102 may be configured to generate object recognition information based on sensing data. The object recognition information may include information on the presence or absence of an object, position information about the object, information on a distance between the vehicle 100 and the object, and information on a relative speed between the vehicle 100 and the object. In the exemplary embodiment of the present disclosure, the external objects may be various objects related to the operation of the vehicle 100.

A second sensor unit 103 may be disposed with a positioning sensor 103a, a wheel sensor 103b, an attitude sensor 103c, and the like, to confirm its own location, speed, driving attitude, and the like. The attitude sensor 103c may include a gyro sensor, an angular velocity sensor, an acceleration sensor, or the like. The attitude sensor may be an inertial measurement unit (IMU) sensor and may be disposed with a 3-axis accelerometer and a 3-axis gyroscope. The attitude sensor may measure acceleration in a traveling direction (x), acceleration in a lateral direction (y), and acceleration in a height direction (z) of the vehicle 100, and a yaw, a pitch, and a roll as the angular velocity of the vehicle.

The second sensor unit 103 may be configured to generate vehicle driving information based on sensing data. The vehicle driving information may be information generated based on data detected by various sensors disposed inside the vehicle. For example, the vehicle driving information may include vehicle attitude information, vehicle speed information, vehicle inclination information, vehicle weight information, vehicle direction information, vehicle battery information, vehicle fuel information, vehicle tire pressure information, vehicle steering information, vehicle interior temperature information, vehicle interior humidity information, pedal position information, engine temperature information, and the like.

Furthermore, the vehicle driving information may include path information. The path information may refer to information generated based on a destination input by a vehicle user through the operating unit 106. The path information may refer to information that indicates a traveling path from a current position of a host vehicle to a destination on a map when the destination has been set. When no destination is set, the path information may refer to information including a road on which the host vehicle is currently traveling and a future driving path including the road.

The operating unit 106 may be configured as a module that is controlled by the user for driving. For example, the operating unit 106 may be a steering wheel for manual driving, an automatic or manual shift transmission, an accelerator pedal, a brake pedal, or the like. The operating unit 106 may be further disposed with an interface for enabling or disabling an autonomous driving mode and selecting detailed functions requested by the user so that the user may use an autonomous driving function. To receive various requests related to autonomous driving, the operating unit 106 may be configured, for example, as a hard-type interface disposed at a predetermined position inside the vehicle 100, or as a soft-type interface that can be touched on the display 108. Depending on the specifications of the autonomous vehicle, at least one of the steering wheel, the transmission, and the pedal may be omitted. For another example, the operating unit 106 may be disposed with a module that receives a user's control request for the load device 114 in addition to driving control.

The display 108 may function as a user interface. The display 108 may output and display an operating state, a control state, path/traffic information, remaining energy amount information, content requested by the driver, or the like, of the vehicle 100 by the processor 130. Furthermore, the display 108 may be configured as a touch screen configured for detecting a driver's input to receive a driver's request to instruct the processor 130.

The load device 114 is disposed on the vehicle 100 and may be a type of non-driving electrical device not including a driving power system such as the wheel driving unit 118 or the like. The load device 114 is an auxiliary device that receives electric power from the energy generating unit 110, and may be, for example, an air conditioning system, a lighting system, a seat system, various devices disposed in the vehicle 100, or the like. In an exemplary embodiment of the present disclosure, a cooling/heating system that cools or heats at least one of a battery, a fuel cell, an internal combustion engine, an air conditioning system, and a specific part of the vehicle 100 may be further included.

The transceiver 112 may support mutual communication with the server 200, the ITS device 300, adjacent vehicles 300, and the like. The transceiver 112 may include a module that processes, for example, cellular communication, WAVE, DSRC communication, and the like. In an exemplary embodiment of the present disclosure, the transceiver 112 may transmit data generated or stored while driving to the server 200 and receive data and software modules transmitted from the server 200. The transceiver 112 may support communication with an electronic device carried by an occupant inside the vehicle 100. In an exemplary embodiment of the present disclosure, the vehicle 100 may transmit and receive data utilized in a method according to an exemplary embodiment of the present disclosure to or from the outside thereof through the transceiver 112.

For example, the transceiver 112 may receive traffic signal information from a traffic signal controller and provide the traffic signal information to the processor 130. Furthermore, the transceiver 112 may receive a control signal from the traffic signal controller and provide the control signal to the processor 130.

Furthermore, the vehicle 100 may include the energy generating unit 110 and the actuating unit 116.

The energy generating unit 110 may be configured to generate and supply driving power and electric power used in a driving power system and a non-driving power system, such as the actuating unit 116. The non-driving power system may be, for example, the sensor unit 102, the operating unit 106, the display 108, the load device 114, and the transceiver 112, but is not limited thereto, and may include various components that implement sensing, interface, communication, and convenience functions, not including components directly involved in driving operations. When the vehicle 100 is driven based on electrical energy, the energy generating unit 110 may be configured as an electric battery charged from the outside thereof, or configured as a combination of an electric battery and a fuel cell that charges the electric battery. In the case of a vehicle driven based on the combination of the electric battery and the fuel cell, the energy generating unit 110 may include a tank that stores materials used to produce electric power for the fuel cell, such as liquefied hydrogen. When the vehicle 100 is driven based on fossil energy, the energy generating unit 110 may be configured as an internal combustion engine. Furthermore, when the vehicle 100 is a hybrid type, the energy generating unit 110 may be disposed as a combination of the internal combustion engine and the electric battery.

The actuating unit 116 may be disposed with at least one module that implements driving operations and perform at least one driving operation among longitudinal control such as acceleration and deceleration and lateral control such as steering, according to a user request from the operating unit 106. To perform driving operations according to a command of the processor 130 by manual operation of the user or autonomous driving, the actuating unit 116 may be disposed with the wheel driving unit 118 and mechanical components and electronic modules for implementing the driving operations in the wheel driving unit 118. When the vehicle 100 is operated based on electrical energy, the actuating unit 116 may include an assembly for transmitting the requested driving operation to the wheel driving unit 118. When the vehicle 100 is operated based on fossil energy, the actuating unit 116 may be disposed with a transmission and a gear module that transmit the power of the internal combustion engine.

The wheel driving unit 118 may include a plurality of wheels, a driving force generation module for generating a driving force and applying the driving force to the wheels or transmitting the driving force, a braking module for slowing down the driving of the wheels, and a steering module for carrying out lateral control of the wheels. When the vehicle 100 is driven based on electrical energy, the driving force generating module may be configured as a motor assembly that generates a driving force based on electric power output from the electric battery. The braking module of the electric-based vehicle 100 may further have a regenerative braking function.

A navigation system 122 may provide navigation information. The navigation information may include at least one of map information, set destination information, path information according to a set destination, information on various objects on the path, lane information, and current vehicle position information.

The navigation system 122 may receive information from an external device through the transceiver 112 and update previously stored information. According to the exemplary embodiment of the present disclosure, the navigation system 122 may be classified as a sub-component of the operating unit 106.

Furthermore, the vehicle 100 may include a memory 120 and the processor 130.

The memory 120 may store applications and various types of data for controlling the vehicle 100, and load applications or read and record data by a request of the processor 130.

The processor 130 may perform overall control of the vehicle 100. The processor 130 may be configured to execute applications and instructions stored in the memory 120.

FIG. 3 is a diagram for describing the operation of an autonomous vehicle control device according to an exemplary embodiment of the present disclosure. Referring to FIG. 3, an autonomous vehicle control device 10 according to the exemplary embodiment of the present disclosure may include a transceiver 11, a sensor 12, a processor 13, and a memory 14.

The transceiver 11 may receive map information including travel trajectory data of adjacent vehicles from a map server 20. The transceiver 11 in FIG. 3 may include the same configuration as the transceiver 11 in FIG. 2.

The map information includes travel trajectory data of adjacent vehicles, and is utilized to generate a lane centerline. The travel trajectory data of adjacent vehicles is data collected by the map server 20 that represents actual driving paths of a plurality of vehicles over a certain time period, and may be used to identify a lane structure or a driving pattern of a road.

In the exemplary embodiment of the present disclosure, the map server 20 aggregates travel trajectory data collected from a plurality of vehicles and provides the travel trajectory data to the transceiver 11.

The sensor 12 may detect an external object around the vehicle to generate object recognition information and collect vehicle driving data to generate vehicle driving information. The sensor 12 in FIG. 3 may include the first sensor unit and the second sensor unit in FIG. 2.

In the exemplary embodiment of the present disclosure, the object recognition information includes road boundary information (e.g., road edge portion) and lane mark information (e.g., lane line), which provide environmental information needed to determine a location of a lane centerline. Furthermore, the sensor 12 collects the vehicle driving data to generate the vehicle driving information. The vehicle driving information includes travel trajectory data of the host vehicle (autonomous vehicle), which represents paths along which the host vehicle actually travels.

The processor 13 and the memory 14 in FIG. 3 may include the same configuration as the processor 130 and the memory 120 in FIG. 2.

The processor 13 collects object recognition information from the sensor 12 disposed in the autonomous vehicle. The sensor 12 includes various types of sensors 12 such as a camera, a Light Detection and Ranging (LiDAR), a radio detection and ranging (RADAR), and an ultrasonic sensor 12, and the sensors detect the environment around the vehicle to generate object recognition information. The object recognition information includes obstacles, vehicles, pedestrians, road signs, lane lines, and other changes in the driving environment on the road. For example, the camera photographs images of lane lines, signs, and cones or barricades in a construction zone on the road to generate visual data, and the LiDAR provides distances and locations of objects on the road as 3D point cloud data. The radio detection and ranging (RADAR) detects the speed and location of a moving or stationary vehicle, and the ultrasonic sensor 12 detects a close-range obstacle (e.g., a parked and stationary vehicle).

The processor 13 fuses data from the sensors 12 to generate object recognition information. Data fusion includes a process of generating a coherent environment model synchronizing data from each sensor 12 in time and integrating coordinate systems of the respective sensor 12. For example, accurate 3D location is determined by mapping the locations of barricades in a construction zone detected by the camera with LiDAR data. The processor 13 may be configured to determine the lane centerline on the driving road based on the vehicle driving information and object recognition information.

The processor 13 may be configured to determine the lane centerline based on the travel trajectory data of adjacent vehicles included in the map information, the travel trajectory data of the host vehicle included in the vehicle driving information, and the road boundary information and lane mark information included in the object recognition information.

In the following embodiments, the vehicle travel trajectory data may be used to refer to data including a travel trajectory of the host vehicle included in the vehicle driving information and a travel trajectory of another vehicle included in the map information.

The processor 13 may be configured to determine the lane centerline based on the travel trajectory data included in the vehicle driving information.

The processor 13 may determine, based on initial trace data included in the vehicle driving information, a point to which the average of points where a perpendicular line drawn at an initial trace meets iteratively converges as a center point of the lane centerline (centerline point).

The processor 13 is configured to determine the lane centerline based on data collected from the transceiver 11 and the sensor 12. The processor 13 comprehensively analyzes the travel trajectory data of adjacent vehicles included in the map information, the travel trajectory data of the host vehicle included in the vehicle driving information, and the road boundary information and lane mark information included in the object recognition information. Since the travel trajectory data of adjacent vehicles reflects paths along which a plurality of vehicles travel, the travel trajectory data is applied to identify a general driving pattern on the road, while the travel trajectory data of the host vehicle reflects a current driving situation of the vehicle. Furthermore, road boundary information and lane mark information define a physical structure of the road so that the lane centerline is generated at an appropriate location within the road. For example, the road boundary information indicates both edge portions of the road, and the lane mark information indicates the location of lane lines. These pieces of information are used to correct the lane centerline so that the lane centerline is centered within the lane.

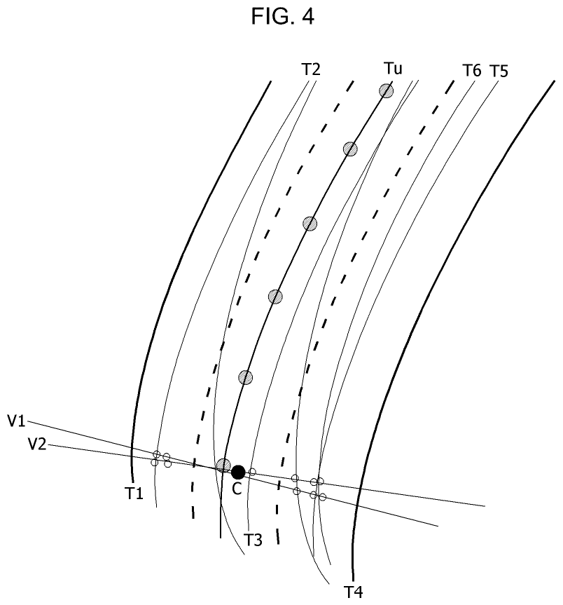

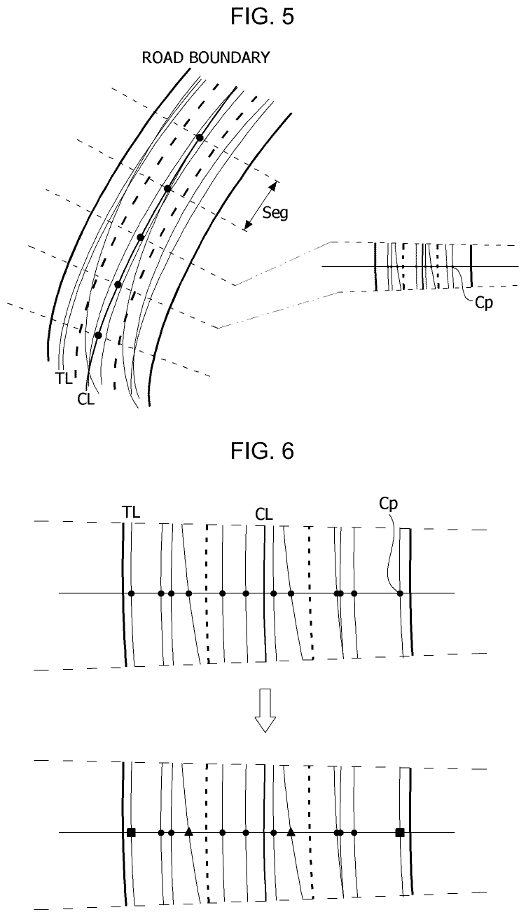

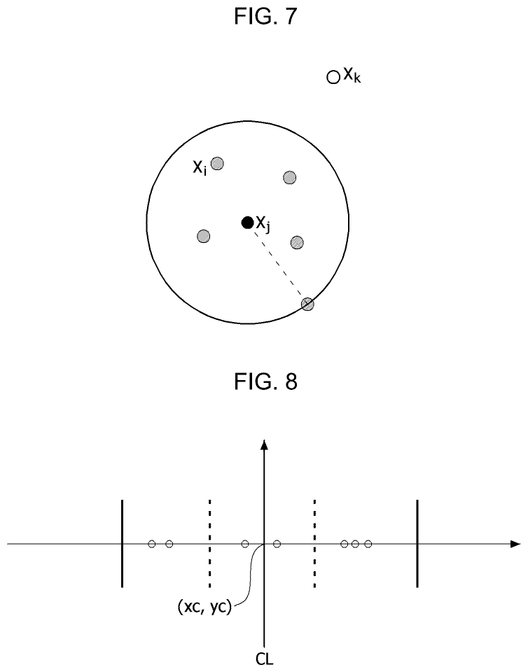

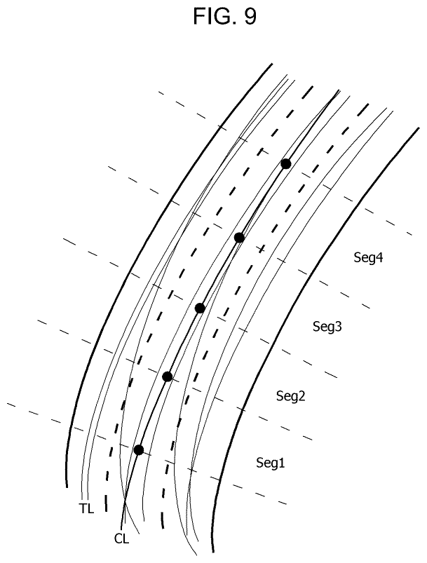

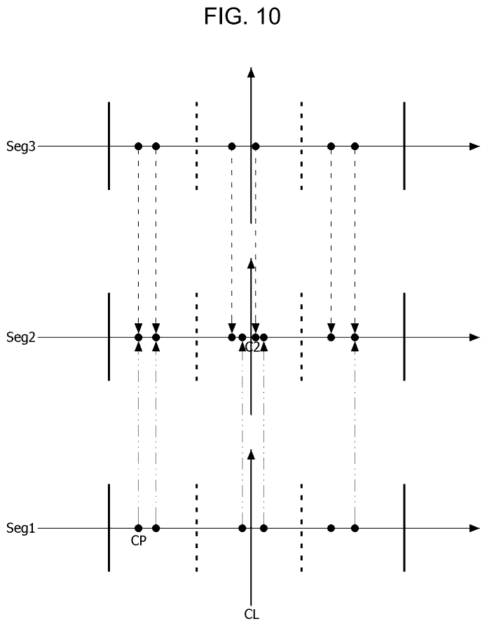

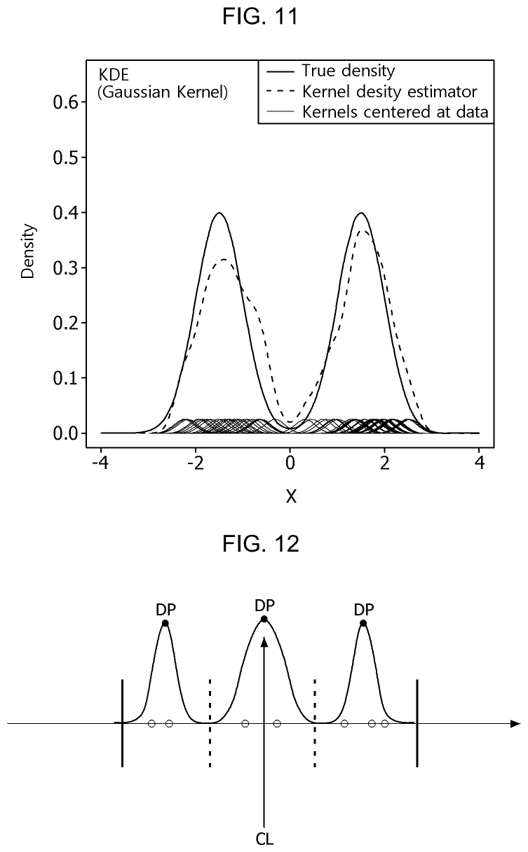

FIG. 4 is a view for describing the operation of the processor according to an exemplary embodiment of the present disclosure. Referring to FIG. 4 together, the processor 13 is configured to perform an algorithm for determining a lane centerline based on travel trajectory data included in vehicle driving information. In the present process, the processor 13 utilizes initial trace data. The initial trace data represents an initial path selected from travel trajectory data of the host vehicle included in the vehicle driving information or travel trajectory data of adjacent vehicles included in the map information. The initial trace may be randomly selected, and serves as a starting point for generating the lane centerline.

The processor 13 draws a perpendicular line V₁ on an initial trace T_{L} and is configured to determine points where the perpendicular line intersects travel trajectories T1, T2, T3, T4, T5 and T6. The present perpendicular line is drawn at a specific point on the initial trace T_{Li} in a direction perpendicular to a tangent at the corresponding point. The points where the perpendicular line intersects the travel trajectories T1, T2, T3, T4, T5 and T6 represent a distribution of the travel trajectories, and the processor 13 collects coordinates of these points.

The processor 13 is configured to determine an average position of the points where the perpendicular line V₁ intersects the travel trajectories T1, T2, T3, T4, T5 and T6. The average position is determined by summing the coordinates of the collected points and dividing the result by the number of points. For example, when there are five points where the perpendicular line V₁ intersects the travel trajectories T1, T2, T3, T4, T5 and T6, and the coordinates of each point are: (x₁, y₁), (x₂, y₂), . . . , (x₅, y₅), the coordinates of the average position are determined as ((x₁+x₂+ . . . +x₅)/5, (y₁+y₂+ . . . +y₅)/5). The present average position is set to a center point C of the lane centerline. However, since an initial average position may not fully reflect the distribution of the travel trajectories T1, T2, T3, T4, T5 and T6, the processor 13 corrects the center point through an iterative convergence process.

In the iterative convergence process, the processor 13 compares the average position determined in a previous stage (hereinafter P_prev) with an average position determined in a current stage (hereinafter P_curr). The processor 13 draws a perpendicular line V₂ at P_prev again, is configured to determine points where the perpendicular line V₂ intersects the travel trajectories, and obtains an average position P_curr of these points. Accordingly, the processor 13 is configured to determine a distance difference between P_prev and P_curr. The present distance difference is determined as the Euclidean distance between the two points, and is mathematically expressed as √((P_prev.x−P_curr.x)²+(P_prev.y−P_curr.y)²). The processor 13 repeatedly updates the average position until the distance difference becomes smaller than a preset threshold value F. That is, when |P_prev−P_curr|<ε is satisfied, the iteration is terminated, and the final determined average position is determined as the center point C of the lane centerline. The present threshold value F is a pre-set value and is set to a very small value (e.g., 0.01 m) to ensure that the center point is sufficiently converged.

This iterative convergence process ensures that the lane centerline accurately reflects the distribution of the travel trajectories T1, T2, T3, T4, T5 and T6. For example, when the road is a curved section, the initial trace T_{L}, may be biased toward the external edge portion of the curve. For example, when the initial trace T_{L}, is simply used as the lane centerline, it is a highly likely to deviate from the center portion of the lane. However, through the iterative convergence process, the processor 13 gradually analyzes the distribution of the travel trajectories and derives the center point disposed at the center portion of the lane. The processor 13 generates a lane centerline connecting the determined center points of the lane.

The processor 13 may divide the driving road into a plurality of segments based on the lane centerline on the driving road.

Furthermore, the processor 13 may divide the segments based on a center point of the lane centerline, and determine a vehicle travel trajectory that intersects the lane centerline at the same longitudinal position as a cross point.

For example, the processor 13 may be configured to determine a point where the vehicle travel trajectory intersects the line that passes through the center point of each segment and is perpendicular to the lane centerline as a cross point.

The center points determined by the processor 13 are disposed at regular intervals on the lane centerline, and each center point is configured as a reference point indicating the center portion of the lane. The processor 13 divides the road into segments based on these center points. A segment is a section of the road disposed by dividing the road into units of a certain length along the lane centerline, and each segment includes one center point. For example, when the lane centerline is 100 m long and the length of a segment is set to 5 m, the processor 13 divides the lane centerline into 20 segments. For example, each segment is 5 m long, and the center point of each segment is a center point on the lane centerline disposed at a midpoint of the corresponding segment.

In the segmentation process, the processor 13 defines a segment based on the center point of the lane centerline. The processor 13 generates segments by dividing the center points on the lane centerline at regular intervals. The interval is a preset value and may be adjusted depending on the curvature of the road or driving environment. For example, on a straight road, the segment length may be set to be long, but on a curved road, the segment length may be set to be short to reflect the changes in curvature in detail.

Furthermore, the processor 13 divides a road into segments by considering a road structure. For example, in a road belt, the processor 13 generates a lane centerline in a form of a straight or curve line connecting two terminal lines, and segments are uniformly divided along the lane centerline. On the other hand, in an intersection belt, since the lane centerline reflects the complex structure of the intersection, the processor 13 adjusts the spacing between the center points by considering entry and exit paths of the intersection when dividing into the segments.

After diving into the segments is completed, the processor 13 extracts a cross point of a vehicle travel trajectory in each segment. The cross point is a point where the vehicle travel trajectory intersects the lane centerline based on the center point of the segment. To the present end, the processor 13 draws a line that passes through the center point of each segment and is perpendicular to the lane centerline. The present perpendicular line is generated at the corresponding center point of the lane centerline in a direction perpendicular to a tangent to the lane centerline. For example, when the lane centerline is a straight line, the perpendicular line is drawn at a 90-degree angle to the lane centerline, and when the lane centerline is a curved line, the perpendicular line is drawn in a direction perpendicular to a tangent to the curve line at the corresponding center point. The present perpendicular line may extend in a width direction of the road and may extend to a roadside or a lane mark.

The processor 13 extracts a point where the present perpendicular line intersects a vehicle travel trajectory as a cross point. The vehicle travel trajectory includes travel trajectory data of the host vehicle and travel trajectory data of adjacent vehicles, and is obtained from vehicle driving information collected from the sensors 12 and map information received from the map server 20 through the transceiver 11. For example, when a line that passes through the center point of a specific segment and is perpendicular to the lane centerline is drawn and there are three vehicle travel trajectories that intersect the present line, the processor 13 extracts three points where the perpendicular line intersects each travel trajectory as cross points. The cross points indicate positions at which the vehicle travel trajectories are distributed in the width direction of the road based on the lane centerline. That is, the cross points are utilized as an indicator to show how far vehicle driving paths deviate from the lane centerline in the perpendicular direction.

During the cross point extraction process, the processor 13 is configured to perform geometric operations to determine the intersection of the vehicle travel trajectories and the perpendicular line. For example, when the center point of the lane centerline is disposed at (x_{c}, y_{c}) and a direction vector of the lane centerline is (dₓ, d_{y}), a direction vector of a line perpendicular to the lane centerline at the corresponding center point is determined as (−d_{y}, dₓ). When extending the perpendicular line along the present direction vector, the equation of the perpendicular line is expressed as (x, y)=(x_{c}, y_{c})+t(−d_{y}, dₓ) (here, t is a real number). Meanwhile, a vehicle travel trajectory may be represented as a path including a series of points, and for example, when the travel trajectory extends from (x₁, y₁) to (x₂, y₂) as a line segment, the equation of the present line segment is expressed as (x, y)=(x₁, y₁)+s((x₂−x₁), (y₂−y₁)) (here, s is a real number between 0 and 1). The processor 13 is configured to determine an intersection point by solving these two equations simultaneously. That is, values of t and s that satisfy (x_{c}+t(−d_{y}), y_{c}+t(dₓ))=(x₁+s(x₂−x₁), y₁+s(y₂−y₁)) are found, and coordinates of the corresponding intersection point are determined as a cross point.

FIG. 5 is a view for describing the operation of the processor according to the exemplary embodiment of the present disclosure. Referring to FIG. 5 together, the processor 13 generates a cross point Cp at a point where a line perpendicular to a lane centerline, by extending in a width direction of a road, intersects a vehicle travel trajectory TL. In FIG. 5, the lane centerline CL is indicated by a thick line, and segments Seg are indicated as sections separated at regular intervals along the lane centerline CL. The vehicle travel trajectory TL is indicated by a solid line within a road boundary, and the point where the perpendicular line intersects the travel trajectory TL is indicated by the cross point Cp.

The processor 13 may filter cross points based on a difference value between a heading direction of the lane centerline and a heading direction of the vehicle travel trajectory.

The processor 13 may transform the filtered cross points into a center point coordinate system of the lane centerline.

FIG. 6 is a view for describing the operation of the processor according to the exemplary embodiment of the present disclosure. Referring to FIG. 6 together, the processor 13 is configured to determine a difference between the heading direction of the lane centerline CL and the heading direction of the vehicle travel trajectory TL to filter the cross point Cp. The heading direction of the lane centerline indicates a direction in which the lane centerline CL runs at the center point on the lane centerline CL, and is defined as a tangent vector of the lane centerline CL. For example, when the lane centerline CL is expressed as a line segment connecting two center points (x₁, y₁) and (x₂, y₂), the heading direction is determined as a direction of the vector (x₂−x₁, y₂−y₁). The direction of the present vector is expressed as an angle via the a tan 2(y₂−y₁, x₂−x₁) function, and indicates the direction in which the lane centerline CL runs on the road.

Meanwhile, the heading direction of the vehicle travel trajectory TL indicates the direction in which the travel trajectory TL runs at the cross point Cp. When the travel trajectory TL is expressed by two points (xₐ, yₐ) and (x_{b}, y_{b}), which includes the cross point Cp, the heading direction is determined as a direction of a vector (x_{b}−xa, y_{b}−yₐ), and similarly expressed as an angle through the a tan 2(y_{b}−yₐ, x_{b}−xₐ) function.

The processor 13 is configured to determine a difference between the heading direction of the lane centerline CL and the heading direction of the vehicle travel trajectory TL. The present difference is determined as the absolute difference between the two angles, and for example, when the heading direction of the lane centerline CL is 30 degrees and the heading direction of the vehicle travel trajectory TL is 45 degrees, the difference value is |30−45|=15 degrees. The processor 13 filters the cross point CP whose difference value exceeds a preset threshold value. The cross point filtered based on the heading direction is represented in a triangle shape at a lower portion of FIG. 6, and the threshold value may be set in advance.

This is because when the vehicle travel trajectory significantly deviates from the direction of the lane centerline, the corresponding cross point is unlikely to accurately reflect the driving path within the lane. For example, when a vehicle changes lanes or travels on an unusual path, the heading direction of the corresponding travel trajectory may differ significantly from the heading direction of the lane centerline. The processor 13 removes these cross points, thereby leaving the highly reliable cross points.

Furthermore, the processor 13 is configured to perform density-based filtering. To the present end, the processor 13 applies a local outlier factor (LOF) to remove outlier cross points CP including large position errors. The LOF is an algorithm that detects outliers based on the density of data points, and is used to identify low-density points in the distribution of cross points CP.

In the exemplary embodiment of the present disclosure, the LOF is an algorithm that identifies outliers by comparing local densities of data points, and is effective in datasets having non-uniform density distribution. In the exemplary embodiment of the present disclosure, the processor 13 applies the LOF considering that the distribution of cross points CP may be non-uniform depending on the structure of the road or driving pattern. For example, in a curved section of a road, cross points CPs may be distributed toward an external edge portion of the curve, and the LOF accurately detects outliers in such a non-uniform distribution. The cross points filtered based on density are represented in a square shape at the lower portion of FIG. 6.

FIG. 7 is a view for describing the operation of the processor according to the exemplary embodiment of the present disclosure. Referring to FIG. 7 together, the processor 13 first is configured to determine a reachability distance RD between cross points to determine the LOF. The reachability distance is an indicator that measures the distance between a specific cross point xᵢ and another cross point xⱼ, and utilizes a larger value between a k-distance and an actual distance. The k-distance refers to a distance to a k-th closest cross point based on xⱼ. For example, when k=5, the k-distance of xⱼ is the Euclidean distance from xⱼ to the 5-th closest cross point. The actual distance is determined as the Euclidean distance between xᵢ and xⱼ, which is expressed as √((x_i.x−x_j.x)²+(x_i.y−x_j.y)²). The reachability distance is defined as the larger of these two values. That is, the reachability distance between xᵢ and xⱼ is determined as max(k−distance(xⱼ), dist(x₁, xⱼ)). The processor 13 maintains consistency in density determination using the k-distance when xᵢ is within k-distance from xⱼ, otherwise using the actual distance.

Next, the processor 13 is configured to determine a local reachability distance (LRD) that indicates the degree of density with k cross points in the vicinity of a reference cross point. The LRD is an indicator that measures the density of the reference cross point Y, and is determined based on the average of the reachability distances to k cross points in the vicinity of Y. The LRD is defined as a value obtained by dividing 1 by the average of the reachability distances to k cross points in the vicinity of Y That is, LRD is determined as LRD(Y)=1/((Σ_{xᵢ ∈ Nk(Y)}RD(Y, xᵢ))/|Nk(Y)|). Here, Nk(Y) denotes a set of k-nearest neighbor cross points of Y, and |Nk(Y)| denotes a size of the present set (that is, k). A smaller LRD value indicates that Y is farther away from nearby cross points, which means that Y is disposed in a low-density region.

The processor 13 is configured to determine the LRD value based on the LRD difference of the cross points in the vicinity of k compared to the reference cross point. The LOF is defined by determining the ratio between the LRD of the reference cross point Y and the LRDs of the k-nearest neighbor cross points of Y The LOF is determined as LOF(Y)=(Σ{xᵢ ∈ Nk(Y)}LRD(xᵢ)/LRD(Y))/|Nk(Y)|. The present This indicates how much larger the LRDs of the cross points in the vicinity of Y are than the LRD of Y A LOF value close to 1 means that Y has a similar density to the nearby cross points, while a LOF value greater than 1 means that Y has a lower density than the nearby cross points and is considered an outlier. The processor 13 classifies cross points including a LOF value greater than 1 as outliers and removes the cross points. For example, when the LOF value of a specific cross point is determined as 1.5, the present cross point is determined to be an outlier since the cross point has a low density compared to the nearby cross points and is filtered.

FIG. 8 is a view for describing the operation of the processor according to the exemplary embodiment of the present disclosure. Referring to FIG. 8 together, the processor 13 transforms filtered cross points into the center point coordinate system of the lane centerline CL. The center point coordinate system of the lane centerline CL refers to a local coordinate system that utilizes the center point of each segment as the origin and the direction of the lane centerline CL as a reference axis. For example, when the center point of a specific segment is located at (x_{c}, y_{c}) and the direction vector of the lane centerline is (dₓ, d_{y}), an x-axis of the center point coordinate system is set in the direction of (dₓ, d_{y}), and a y-axis is set in the direction of (−d_{y}, dₓ). In the present coordinate system, the center point (x_{c}, y_{c}) is transformed to (0, 0).

The processor 13 transforms the coordinates of the filtered cross points into coordinates in the present center point coordinate system. When the original coordinates of the cross point are (xₚ, yₚ), the processor 13 first translates the cross point parallel to the center point. That is, the coordinates are moved to (xₚ−x_{c}, yₚ−y_{c}). Accordingly, the processor 13 is configured to perform a rotation transformation based on the direction vector of the lane centerline. The rotation transformation is performed based on the angle θ=a tan 2(d_{y}, dₓ) of the direction vector (dₓ, d_{y}) of the lane centerline. A rotation transformation matrix is expressed as [[cos(θ), −sin(θ)], [sin(θ), cos(θ)]], and new coordinates (x′ₚ, y′ₚ) are determined by multiplying the translated coordinates (xₚ−x_{c}, yₚ−y_{c}) by the present matrix. That is, x′p=(xₚ−x_{c})cos(θ)+(yₚ−y_{c})sin(θ), y′ₚ=−(xₚ−x_{c})sin(θ)+(yₚ−y_{c})cos(θ). The present transformation allows cross points to be expressed in the local coordinate system based on the direction of the lane centerline, and allows consistent analysis of relative positions between cross points in the subsequent drivable path generation process.

The processor 13 may be configured to determine a distribution ratio of the vehicle travel trajectory for each of the segments obtained by dividing the road. Furthermore, the processor 13 may be configured to determine a drivable path connecting segments based on the distribution ratio of the vehicle travel trajectory and control the autonomous vehicle according to the drivable path.

For example, the processor 13 may be configured to determine the drivable path point for each segment based on a sliding window method.

The processor 13 may merge the cross points of adjacent segments and determine drivable path points based on the distribution ratio of the merged cross points.

For example, the processor 13 may merge the cross points of adjacent segments into a central segment coordinate system and estimate a probability density function (PDF) local maximum through kernel density estimation (KDE) and select the drivable path point.

For example, the processor 13 may filter drivable path points through which a preset number of travel trajectories or fewer have passed.

The processor 13 may be configured to generate the drivable path by connecting the drivable path point for each segment.

FIG. 9, FIG. 10, FIG. 11 and FIG. 12 are views for describing the operation of the processor according to the exemplary embodiment of the present disclosure. Referring to FIG. 9, FIG. 10, FIG. 11 and FIG. 12 together, the processor 13 is configured to determine a distribution ratio of vehicle travel trajectories for each of the segments obtained by dividing the road. The processor 13 analyzes the distribution of cross points extracted from each segment to identify how the vehicle travel trajectory is distributed based on the lane centerline. The present distribution ratio provides the basic data needed to generate a drivable path.

As shown in FIG. 9 and FIG. 10, the processor 13 generates drivable path points for each segment based on the sliding window method. For example, a sliding window includes three adjacent segments, and includes a central segment and two segments (hereinafter referred to as side segments) disposed on either side of the central segment. For example, when segments numbered 1 to 4 are sequentially disposed, and the sliding window includes segments 1, 2, and 3, segment 2 (seg2) becomes the central segment, and segment 1 (seg1) and segment 3 (seg3) become the side segments. In the next stage, the window moves one space so that the window includes segments 2, 3, and 4 (seg2 to seg4). In the present way, the sliding window is sequentially applied to all segments (seg1 to seg4).

The processor 13 merges the cross points CP of the side segments in the sliding window into the central segment coordinate system. The central segment coordinate system refers to a local coordinate system that utilizes a center point C2 of the central segment (seg2) as the origin and the direction of the lane centerline as a reference axis. In the merging process, the processor 13 drops a perpendicular H from the cross point CP of the side segments (seg1 and seg3) onto the central segment coordinate system. Dropping the perpendicular H refers to projecting the cross points Cp onto a line (hereinafter referred to as a central perpendicular line) that passes through the center point C2 of the central segment (seg2) and is perpendicular to the lane centerline CL. For example, when the cross point of the side segments (seg1 and seg3) is provided as (xₚ, yₚ), the center point C2 of the central segment (seg2) is disposed at (x_{c}, y_{c}), and the direction vector of the lane centerline CL is (dₓ, d_{y}), the processor 13 is configured to determine the direction vector of the central perpendicular line as (−d_{y}, dₓ).

To project the cross point CP onto the central perpendicular line, the processor 13 projects the vector (xₚ−x_{c}, yₚ−y_{c}) between the cross point CP and the center point onto the direction vector (−d_{y}, dₓ) of the central perpendicular line. The projected coordinates are transformed into points on the central perpendicular line, and the points are expressed as coordinates in the y-axis direction in the central segment coordinate system.

The processor 13 analyzes the distribution ratio of the merged cross points to determine the drivable path points. For the present purpose, the processor 13 estimates the PDF local maximum through KDE. KDE is a method of estimating data distribution by dividing the sum of cross point data weighted using a kernel function by the total number. The processor 13 defines a density estimation value at a specific position x as fₕ(x)=(1/n)*Σ{i=1}\hat{ }n Kₕ(x−xᵢ) when the cross points are provided as x₁, x₂, . . . , xₙ. Here, Kₕ is a kernel function, and in the exemplary embodiment of the present disclosure, a Gaussian kernel is used as shown in FIG. 11. The Gaussian kernel is expressed as Kₕ(u)=(1/N(2πh²))*exp(−u²/(2h²)), where h is a bandwidth that is set in advance. The bandwidth h determines the degree of smoothness of the density estimation, and a smaller h makes the estimation more sensitive to data, while a smoother density curve is generated as h is increased.

KDE is a nonparametric method widely used in the fields of statistics and machine learning to estimate data distributions, and the processor 13 estimates a continuous density function by applying the kernel function around a data point. Furthermore, the processor 13 is configured to determine the density of the vehicle travel trajectories by estimating the distribution of cross points using the Gaussian kernel.

The processor 13 selects drivable path points by estimating the PDF local maximum determined through KDE. The PDF local maximum represents a position where the cross points are most densely concentrated, and represents paths along which vehicle travel trajectories pass most frequently. For example, when the PDF determined via KDE in a specific segment has two local maxima as shown in FIG. 11, this indicates that the vehicle travel trajectory in the corresponding segment is divided and distributed into two main paths.

As shown in FIG. 12, the processor 13 selects positions corresponding to these local maxima as drivable path points (DPs). The processor 13 visualizes PDF local maxima as peaks of the density curve on the graph, which intuitively shows positions where the distribution of cross points is concentrated.

The processor 13 filters points through which a preset number of travel trajectories or fewer have passed among the selected drivable path points. This is a process for removing drivable path points having low reliability. For example, when a system designer sets the minimum number of travel trajectories to 3, when there are 2 or fewer travel trajectories passing through a specific drivable path point, the processor 13 filters the corresponding point. This ensures that drivable path points are generated based on sufficient driving data, and prevents points generated by a small number of abnormal travel trajectories from being included in the driving path.

FIG. 13 and FIG. 14 are views for describing the operation of the processor according to the exemplary embodiment of the present disclosure. Referring to FIG. 13 and FIG. 14 together, the processor 13 generates a drivable path by connecting drivable path points generated in a sliding window. As shown in FIG. 13, the processor 13 analyzes a connection relationship between drivable path points based on a connectivity matrix. The connectivity matrix connects a drivable path point of an N-th segment to a drivable path point of an N+1-th segment, and represents a connection probability between each point. The (s, t) value of the connectivity matrix is determined as a proportion of travel trajectories that pass through a t-th drivable path point of the (N+1)-th segment among travel trajectories that have passed through an s-th drivable path point of the N-th segment.

The connectivity matrix is a technique used in graph theory to analyze path connectivity, and represents a transition probability between each state (drivable path point). In the exemplary embodiment of the present disclosure, the processor 13 may be configured to generate a drivable path reflecting an actual driving pattern by determining the transition probability based on travel trajectory data.

The processor 13 compares the drivable path points DP of the N-th segment and the N+1-th segment. For example, when there are three drivable path points (1, 2, 3) in the N-th segment and three drivable path points (1, 2, 3) in the N+1-th segment, the connectivity matrix is represented as a 3×3 matrix. The processor 13 is configured to determine the total number of travel trajectories that pass through the s-th drivable path point of the N-th segment.

The processor 13 is configured to determine the number of travel trajectories that pass through the t-th drivable path point of the N+1-th segment among these travel trajectories. The (s, t) value is defined as the proportion determined from these two numbers. For example, when there are four travel trajectories that pass through a first drivable path point of the N-th segment, and three thereof pass through a first drivable path point of the N+1-th segment, the (1,1) value of the connectivity matrix is determined as ¾=0.75.

As shown in FIG. 14, the processor 13 may be configured to determine a connectivity matrix expressed as [[0.75, 0.25, 0], [0, 1, 0], [0, 0.25, 0.75]]. This indicates that the probability that the first point of the N-th segment is connected to the first point of the N+1-th segment is 0.75, and the probability that the first point of the N-th segment is connected to a second point thereof is 0.25.

The processor 13 generates the drivable path by connecting drivable path points based on the connectivity matrix. The processor 13 preferentially selects a path having a high probability value in the connectivity matrix, and in the present way, is configured to determine a path from the N-th segment to the N+1-th segment. For example, when the (1,1) value of the connectivity matrix is 0.75, which is the highest value, the processor 13 connects the first drivable path point of the N-th segment to the first drivable path point of the N+1-th segment.

The processor 13 applies the present process sequentially to all segments to generate an entire drivable path. The generated drivable path is used as a driving path of the autonomous vehicle, and the processor 13 is configured to control the autonomous vehicle according to the present path.

Furthermore, the processor 13 analyzes object recognition information to determine real-time road situations. The processor 13 detects a construction zone based on the object recognition information through barricades, construction signs, or lane change guidance signs disposed on the road. For example, when the camera recognizes a “Under Construction” sign or the LiDAR detects an abnormally disposed object (e.g., a cone) on the road, the processor 13 classifies a corresponding zone as a construction zone. Furthermore, the processor 13 detects an accident zone through stopped vehicles on the road, damaged vehicles, or abnormal vehicle movements (e.g., sudden stops). Furthermore, when the radio detection and ranging (RADAR) detects a vehicle stopped in the middle portion of the road or the camera recognizes a situation where a lane is blocked due to an accident, the processor 13 is configured to determine the zone as an accident zone. Furthermore, the processor 13 detects a parking zone through vehicles stopped on a roadside or parked vehicles. Furthermore, the processor 13 classifies the zone as a parking zone when the ultrasonic sensor 12 detects a vehicle approaching the roadside or the camera recognizes the outline of a parked vehicle. Furthermore, the processor 13 may detect a temporary road situation change (e.g., pedestrian crossing, occurrence of a fallen object) through the object recognition information. For example, when the camera recognizes a pedestrian on the road or the LiDAR detects an object that has fallen on the road, the processor 13 considers this as a real-time road situation.

The processor 13 updates the drivable path by reflecting the real-time road situation. The drivable path is a path constructed based on previously generated drivable path points and the connectivity matrix, and is defined for each segment along the lane centerline. When the real-time road situation is detected, the processor 13 readjusts the drivable path points of the corresponding zone or generates an alternative path.

The processor 13 identifies a zone where the real-time road situation occurs. For example, when a construction zone occurs from segment 5 to segment 7, the processor 13 is configured to perform an update on the drivable path points included in the corresponding segments. In the case of the construction zone, the processor 13 analyzes the object recognition information and identifies lanes blocked due to construction and available lanes. When the camera recognizes a lane change guidance sign (e.g., “Move to the right lane”) in the construction zone, the processor 13 readjusts the drivable path point of the corresponding zone to move to the right lane. To the present end, the processor 13 reanalyzes cross points in the construction zone, estimates new PDF local maxima through KDE and updates drivable path points. For example, when the left lane is blocked due to construction, the processor 13 regenerates drivable path points using cross points corresponding to the right lane, excluding cross points corresponding to the left lane.

Furthermore, the processor 13 updates the drivable path in the accident zone. The road may be partially or fully blocked in the accident zone. For example, when the LiDAR detects a stopped vehicle in the middle portion of the road in segment 6, the processor 13 is configured to determine whether the drivable path point of the corresponding segment overlaps the stopped vehicle. When the drivable path point of the corresponding segment overlaps the stopped vehicle, the processor 13 removes the corresponding drivable path point and generates an alternative path using a nearby lane. Alternative path generation is performed by redetermining the connectivity matrix. The processor 13 selects a path that connects the drivable path points of the segment before the accident zone (e.g., segment 5) and the segment after the accident zone (e.g., segment 7), but bypasses the accident zone. For example, when the center lane is blocked due to an accident, the processor 13 generates a path for moving to the left or right lane, and updates the (s, t) value of the connectivity matrix for the present purpose. The updated connectivity matrix is adjusted to increase the connection probability of the path that avoids the accident zone.

Furthermore, the processor 13 updates the drivable path in the parking zone. In the parking zone, a drivable region may be narrowed due to vehicles parked on the side of the road. For example, when the ultrasonic sensor 12 detects a parked vehicle on the right side of the road in segment 8, the processor 13 is configured to determine whether the drivable path point of the corresponding segment collides with the parked vehicle. When the drivable path point of the corresponding segment collides with the parked vehicle, the processor 13 adjusts the drivable path point to move to the left to avoid the parked vehicle. To the present end, the processor 13 reanalyzes the cross point of the corresponding segment and regenerates a drivable path point using remaining cross points excluding the region where the parked vehicle is disposed (e.g., 1 m wide right side of the road). Furthermore, the processor 13 adjusts the drivable path point to return to the original lane at an ending point of the parking zone (e.g., segment 9) by considering the length and position of the parked vehicle.

Furthermore, the processor 13 updates the drivable path by reflecting a temporary change in the road situation. For example, when the camera detects a pedestrian crossing the road in segment 10, the processor 13 temporarily removes the drivable path point of the corresponding segment and adjusts the path to wait until the pedestrian safely passes. After the pedestrian passes, the processor 13 restores the original drivable path point. As an exemplary embodiment of the present disclosure, when the LiDAR detects a fallen object (e.g., a tree branch) on the road, the processor 13 analyzes the position and size of the fallen object and adjusts the drivable path point of the corresponding zone to bypass the fallen object. When the fallen object is disposed in the middle portion of the road, the processor 13 generates an alternative path to move to the left or right lane, and for the present purpose, updates the connectivity matrix to increase the connection probability of a detour path.

The processor 13 dynamically adjusts the drivable path according to the real-time road situation. For the present purpose, the processor 13 sets an update cycle of the drivable path. For example, when the update cycle is set to 1 second, the processor 13 analyzes the object recognition information every second and updates the drivable path. In the present process, the processor 13 considers the change rate in the road situation. In a relatively static situation, such as the construction zone, the processor 13 may lower the update frequency, but in a rapidly changing situation, such as the accident zone or pedestrian crossings, the processor 13 increases the update frequency. For example, while a pedestrian is crossing the road, the processor 13 analyzes the object recognition information at 0.1 second intervals, tracks changes in the pedestrian's position in real time and dynamically adjusts the drivable path accordingly.

The processor 13 applies the drivable path in which the real-time road situations are reflected to the control of the autonomous vehicle. When the drivable path is updated, the processor 13 transmits new path data to a driving control module of the vehicle. The driving control module adjusts the speed, steering, and acceleration/deceleration of the vehicle based on the present data. For example, when the drivable path is updated to move to the right lane in the construction zone, the processor 13 generates a steering command to cause the vehicle to perform a lane change to the right. When the detour path is generated in the accident zone, the processor 13 adjusts the speed and path so that the vehicle travels along the detour path. When the path is adjusted to move to the left in the parked zone, the processor 13 is configured to control the steering and speed so that the vehicle may safely avoid the parked vehicle.

Furthermore, the processor 13 may update the drivable path by reflecting additional circumstances such as weather conditions, traffic flow, and road regulations in addition to the real-time road situation. For example, when the sensor 12 detects a weather condition such as rain or fog, the processor 13 adjusts the path to narrow the gap between drivable path points and reduce the speed of the vehicle. When traffic congestion information is received from a traffic information server through the transceiver 11, the processor 13 generates an alternative path that bypasses a traffic congestion zone. Furthermore, when receiving road regulation information (e.g., one-way zone, vehicle entry restricted zone) from the map server 20, the processor 13 generates a path excluding the corresponding zone.

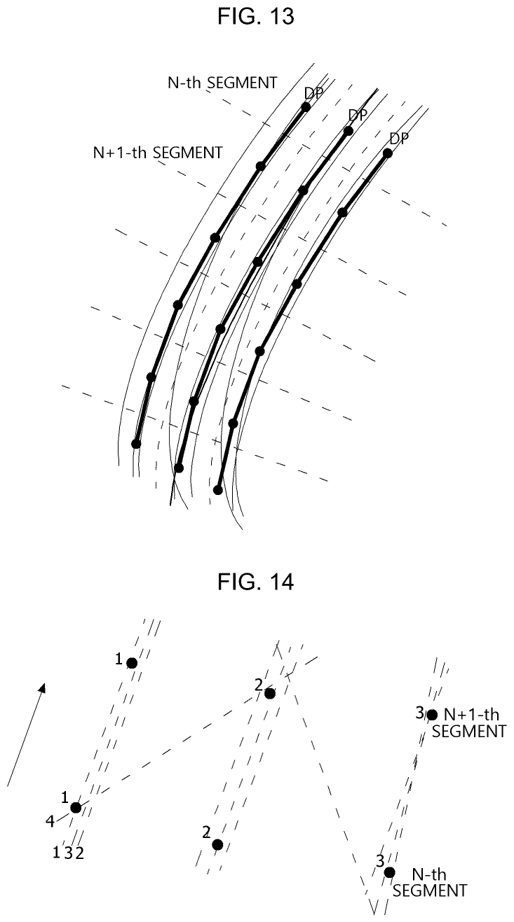

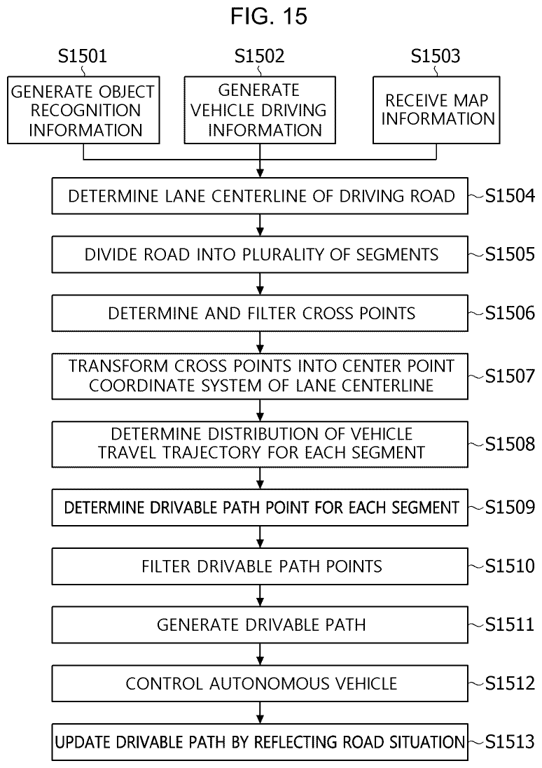

FIG. 15 is a flowchart of a method for controlling an autonomous vehicle according to an exemplary embodiment of the present disclosure. Referring to FIG. 15, when an autonomous vehicle starts traveling, sensors disposed in the vehicle begin to operate. The sensors detect an external environment around the vehicle and generate object recognition information. In the present process, the sensors detect various objects such as obstacles, vehicles, pedestrians, and lane lines on a road and convert the objects into data (S1501).

At the same time, the sensors collect driving data of the vehicle and generate vehicle driving information. The vehicle driving information includes travel trajectory data of the host vehicle, which indicates paths the vehicle actually travels (S1502).

Furthermore, the transceiver communicates with the map server to receive map information including travel trajectory data of adjacent vehicles. The map information includes path data from a plurality of vehicles and is utilized to identify general driving patterns on the road. The present data collection process is simultaneously performed in an initial stage when the autonomous vehicle starts traveling, and provides basic data for subsequent path generation (S1503).

Next, the processor is configured to determine a lane centerline on the driving road based on the collected data. The processor utilizes the travel trajectory data of the host vehicle included in the vehicle driving information and the travel trajectory data of adjacent vehicles included in the map information. Furthermore, the processor accurately is configured to determine the lane centerline by reflecting a road boundary and lane line information through the object recognition information. The lane centerline is a virtual line that runs along the center portion of the lane, and then is configured as a reference for dividing the road and generating a drivable path. The present process is a first stage for an autonomous vehicle to understand the structure of the road and plan a path, and is performed at the beginning of traveling or when entering a new road section (S1504).

After the lane centerline is determined, the processor divides the driving road into a plurality of segments based on the lane centerline. A segment is a section disposed by dividing the road into units of a certain length along the lane centerline, and each segment is defined based on a center point on the lane centerline (S1505).

The processor is configured to determine a point where the vehicle travel trajectory intersects the lane centerline at the same longitudinal position as a cross point. The cross point indicates where the vehicle travel trajectory is distributed in a width direction of the road based on the lane centerline, and then provides data needed to generate a subsequent drivable path. The present process is performed immediately after the lane centerline is generated, and forms a preparatory stage for segmenting the road and analyzing the distribution of travel trajectories. When segmentation and cross point determination are completed, the processor filters cross points. The processor is configured to determine a difference value between a heading direction of the lane centerline and a heading direction of the vehicle travel trajectory. The heading direction refers to a direction in which the lane centerline or travel trajectory extends, and cross points whose difference value exceeds a preset threshold are removed. The present This is a process for excluding cross points generated by abnormal travel trajectories, and the purpose is to leave highly reliable data. The present filtering process is performed immediately after the cross points are extracted and is an important stage for increasing the accuracy of generating a drivable path (S1506).

After filtering is completed, the processor transforms the filtered cross points into a center point coordinate system of the lane centerline. This present is a process of transforming the coordinates of the cross points into a local coordinate system based on the center point of each segment, which makes it possible to continuously analyze relative positions between cross points. The present transformation process is performed immediately after filtering and then the data normalization required to generate drivable path points is completed (S1507).

Next, the processor is configured to determine the distribution of vehicle travel trajectories for each segment. This is the process of analyzing how cross points are distributed based on the lane centerline in each segment (S1508).

The processor is configured to determine the drivable path point for each segment based on the sliding window method. A sliding window includes three adjacent segments, and the processor merges the cross points of adjacent segments. The processor merges the cross points of side segments into the central segment coordinate system, and estimates a PDF local maximum through KDE and selects the drivable path points. KDE is a method of identifying a position having high density by analyzing the distribution of cross points, and the PDF local maximum represents a path through which the largest number of vehicle travel trajectories have passed. The present process is sequentially performed, segment by segment, and is applied to all segments as the sliding window moves along the road (S1509).

After the drivable path points are selected, the processor filters drivable path points through which a preset number of travel trajectories or fewer have passed. This is a process for removing points having low reliability, and for example, when the number of the travel trajectories passing through a specific drivable path point is fewer than a set criterion (e.g., 3), then the corresponding point is excluded. The present filtering process is performed immediately after the drivable path points are generated, and contributes to improving the quality of the drivable path (S1510).

When the drivable path points are finally determined, the processor connects the drivable path points for each segment to generate a drivable path. In the present process, the processor sequentially connects the drivable path points of each segment and maintains continuity between segments to form a smooth path. After the drivable path is generated, the processor applies the present path to the control of the autonomous vehicle. The autonomous vehicle travels along the drivable path, and the processor is configured to control the speed, steering, and acceleration/deceleration of the vehicle to follow the path. The present process is performed immediately after the drivable path is generated and is continuously repeated while the autonomous vehicle is traveling on an actual road (S1511 and S1512).

While the autonomous vehicle is traveling, the processor may update the drivable path in real time by reflecting road situations. For example, when the sensor is configured to detect a construction zone, an accident zone, or a parking zone, the processor readjusts the drivable path points for the corresponding zone or generates an alternative path. The present update process is continuously performed while driving, and allows the autonomous vehicle to adaptively respond to changing road environments (S1513).

The term “~unit” used in an exemplary embodiment of the present disclosure refers to software components or hardware components such as a field-programmable gate array (FPGA) or an application specific integrated circuit (ASIC), and “~unit” is configured to perform certain functions. However, the “~unit” is not limited to software or hardware. The “~unit” may be configured to reside in an addressable storage medium, or may be configured to reproduce one or more processors. Therefore, for example, “~unit” includes components such as software components, object-oriented software components, class components, and task components, and includes processes, functions, attributes, procedures, sub-routines, segments of program code, drivers, firmware, micro code, circuits, data, a database, data structures, tables, arrays, and variables. Functions provided in the components and the “~unit” may be combined into smaller numbers of components and “~units,” or may be further divided into additional components and “~units.” Furthermore, the components and “~units” may be implemented to reproduce one or more CPUs in a device or a security multimedia card.

With an autonomous vehicle control device and method according to an exemplary embodiment of the present disclosure, it is possible to generate a drivable path by utilizing a small amount of vehicle driving data.

Furthermore, it is possible to dynamically update a drivable path by reflecting a real-time road situation.

Furthermore, it is possible to reduce costs by reducing dependence on precision maps.

Furthermore, it is possible to improve the accuracy of path generation by effectively filtering out noise and abnormal data in travel trajectory data.

Furthermore, it is possible to generate smooth and continuous drivable paths by considering continuity between segments.

Furthermore, it is possible to provide flexibility to adaptively respond to various road environments.

Although the exemplary embodiments of the present disclosure have been described above, it is understood that those skilled in the art can make various changes and modifications to the present disclosure without departing from the spirit and scope of the present disclosure set forth in the claims below.

What is claimed is:

1. An autonomous vehicle control apparatus comprising:
a transceiver;
one or more sensors;
one or more processors operatively connected to the transceiver and the one or more sensors; and
a memory storing one or more programs executed by the one or more processors,
wherein the one or more sensors detect an external object around an autonomous vehicle to generate object recognition information and collects driving data of the vehicle to generate vehicle driving information,
wherein the transceiver receives map information including travel trajectory data of adjacent vehicles from a map server, and
wherein the processor:
determines a lane centerline of a driving road based on the vehicle driving information and the object recognition information;
divides the driving road into a plurality of segments based on the lane centerline of the driving road;
determines a distribution of vehicle travel trajectories for each of the divided segments;
determines a drivable path connecting the segments based on the distribution of the vehicle travel trajectories; and
controls the autonomous vehicle according to the drivable path.

2. The autonomous vehicle control apparatus of claim 1, wherein the processor determines the lane centerline based on travel trajectory data included in the vehicle driving information.

3. The autonomous vehicle control apparatus of claim 1, wherein the processor:
divides the segments based on a center point of the lane centerline; and
determines a vehicle travel trajectory that intersects the lane centerline at the same longitudinal position as a cross point.

4. The autonomous vehicle control apparatus of claim 3, wherein the processor filters the cross point based on a difference value between a heading direction of the lane centerline and a heading direction of the vehicle travel trajectory.

5. The autonomous vehicle control apparatus of claim 4, wherein the processor transforms the filtered cross point into a center point coordinate system of the lane centerline.

6. The autonomous vehicle control apparatus of claim 1, wherein the processor determines drivable path points for each segment based on a sliding window method.

7. The autonomous vehicle control apparatus of claim 6, wherein the processor merges cross points of adjacent segments and determines the drivable path points based on a distribution ratio of the merged cross points.

8. The autonomous vehicle control apparatus of claim 7, wherein the processor:
merges the cross points of the adjacent segments into a central segment coordinate system; and
estimates a probability density function (PDF) local maximum through kernel density estimation (KDE) and selects the drivable path points.

9. The autonomous vehicle control apparatus of claim 8, wherein the processor filters drivable path points through which a preset number of travel trajectories or fewer have passed.

10. The autonomous vehicle control apparatus of claim 1, wherein the processor connects drivable path points for each segment to generate the drivable path.

11. An autonomous vehicle control method that is executed by a computing device including a transceiver, one or more sensors, one or more processors operatively connected to the one or more sensors, and a memory storing one or more programs executed by the one or more processors, the method comprising:
detecting, by the one or more sensors, an external object around an autonomous vehicle to generate object recognition information and collecting driving data of the autonomous vehicle to generate vehicle driving information;
receiving, by the transceiver, map information including travel trajectory data of adjacent vehicles from a map server;
determining, by the processor, a lane centerline of a driving road based on the vehicle driving information and the object recognition information;
dividing, by the processor, the driving road into a plurality of segments based on the lane centerline of the driving road;
determining, by the processor, a distribution of vehicle travel trajectories for each of the divided segments;
determining, by the processor, a drivable path connecting the segments based on the distribution of the vehicle travel trajectories; and
controlling, by the processor, the autonomous vehicle according to the drivable path.

12. The autonomous vehicle control method of claim 11, wherein in the determining of the lane centerline of the driving road, the lane centerline is determined based on travel trajectory data included in the vehicle driving information.

13. The autonomous vehicle control method of claim 11, wherein in the dividing of the road into the plurality of segments,
the segments are divided based on a center point of the lane centerline; and
a vehicle travel trajectory that intersects the lane centerline at the same longitudinal position is determined as a cross point.

14. The autonomous vehicle control method of claim 13, further including filtering, by the processor, the cross point based on a difference value between a heading direction of the lane centerline and a heading direction of the vehicle travel trajectory.

15. The autonomous vehicle control method of claim 14, further including transforming, by the processor, the filtered cross point into a center point coordinate system of the lane centerline.

16. The autonomous vehicle control method of claim 11, wherein in the determining of the drivable path, drivable path points for each segment are determined based on a sliding window method.

17. The autonomous vehicle control method of claim 16, wherein in the determining of the drivable path, cross points of adjacent segments are merged and the drivable path points are determined based on a distribution ratio of the merged cross points.

18. The autonomous vehicle control method of claim 17, wherein in the determining of the drivable path, the cross points of the adjacent segments are merged into a central segment coordinate system, a probability density function (PDF) local maximum is estimated through kernel density estimation (KDE) and the drivable path points are selected.

19. The autonomous vehicle control method of claim 18, wherein the determining of the drivable path further includes filtering drivable path points through which a preset number of travel trajectories or fewer have passed.

20. The autonomous vehicle control method of claim 11, wherein the determining of the drivable path includes generating the drivable path by connecting the drivable path point for each segment.
